(19) United States
(12) Patent Application Publication
(10) Pub. No.: US 2025/0181337 A1
(43) Pub. Date: Jun. 5, 2025

(54) SYSTEM AND METHOD OF RUNNING APPLICATION INTEGRATIONS IN A SERVERLESS CLOUD ENVIRONMENT

(71) Applicant: HUAWEI CLOUD COMPUTING TECHNOLOGIES CO., LTD., Gui Zhou Province (CN)

(72) Inventors: JinRong LUO, Kanata (CA); Yu ZHAO, Kanata (CA); Yongjia LUO, Kanata (CA)

(73) Assignee: HUAWEI CLOUD COMPUTING TECHNOLOGIES CO., LTD., Gui Zhou Province (CN)

(21) Appl. No.: 19/051,696

(22) Filed: Feb. 12, 2025

Related U.S. Application Data
(63) Continuation of application No. PCT/CN2022/133281, filed on Nov. 21, 2022.

(51) Int. Cl. G06F 8/60; G06F 9/54

(52) U.S. Cl. CPC G06F 8/60; G06F 9/542; G06F 9/546

(57) ABSTRACT

A system of running application integrations in a serverless cloud environment is provided. Also provided is a method of deploying an integration application and a method of executing an integration application. For integration application deployment, an integration application is converted into a domain specific language (DSL) to obtain a converted integration application. A trigger type in the converted integration application is identified and stored. A trigger binding in accordance with the trigger in the converted integration application is generated. By substituting the trigger binding to the trigger in the converted integration application, a modified integration application is obtained and stored in a registry. For integration application execution, a trigger associated with the integration application is activated and an integration application is retrieved or obtained from the registry database in accordance with the activated trigger. The obtained integration application along with the request payload is transmitted to a dispatcher and the dispatcher further transmits it to an integration runner for execution. Embodiments of the present disclosure can enable scale-to-zero of executing the integration applications in the serverless cloud environment, and also enable cost-effective and reusable integration runners to further optimize the runtime resources in the system.

### CROSS-REFERENCE TO RELATED APPLICATIONS

This application is a continuation of International Patent Application No. PCT/CN2022/133281, filed on Nov. 21, 2022, and titled “System and Method of Running Application Integrations in a Serverless Cloud Environment”, the content of which is incorporated herein by reference in its entirety.

### TECHNICAL FIELD

The present disclosure pertains to software integration, in particular, running the integration application in a serverless cloud environment.

### BACKGROUND

Currently, cloud providers as the third-party software vendors are able to provide an “Enterprise Integration Platform as A Service (EiPaaS)” which can allow enterprises and/or individual developers to design, develop, test and deploy their integration applications in one single place. Some cloud providers offer EiPaaS in serverless cloud environment, where users may only need to pay for the resources consumed by their applications (i.e., the pay-per-used pricing model) without any concerns about the underlining backend services and infrastructure.

Existing EiPaaS solutions in a serverless cloud environment (for example, Apache Camel-K, Function as a Service (FaaS) solutions such as Amazon Web Service (AWS) Lamda service, etc.) have one or more of the following disadvantages: first, the cost of running and maintaining the integration applications will increase rapidly as the number of applications increases (for example, at least one kubernetes pod is running all the time even though there are no upcoming user requests, each kubernets pod can run one integration application only, kubernets pods cannot be reused, or each docker image is required for each customer integration application so too many docker images need to be maintained); second, the integration applications cannot be executed directly and users/developers are required to rewrite functions/codes to integrate and manually bind the functions/codes with the desired trigger; third, not all trigger types are supported (for example, FaaS does not support FTP or email triggers); and the like.

Therefore, there is a need for methods and systems that obviate or mitigate one or more limitations of the prior art.

This background information is provided to reveal information believed by the applicant to be of relevance to the present disclosure. No admission is necessarily intended, nor should be construed, that any of the preceding information constitutes prior art against the present disclosure.

### SUMMARY

An object of aspects of the present disclosure is to provide methods and systems of running application integrations in a serverless cloud environment in a cost-effective way. Accordingly, embodiments may divide the methods and systems into integration application deployment and integration application execution in the serverless cloud environment.

In accordance with an aspect of the present disclosure, there is provided a method of deploying an integration application. In particular, the method includes converting the integration application into a domain specific language (DSL) to obtain a converted integration application. The method further includes identifying a trigger type in the converted integration application. The trigger type identifies the protocol to be invoked to connect to an endpoint. Additionally, the method includes storing the trigger type, generating a trigger binding in accordance with the trigger in the converted integration application, modifying the converted integration application by substituting to the trigger the trigger binding to obtain a modified integration application, and storing the modified integration application in a registry.

In some embodiments, the integration application conversion to the DSL is performed by an integration DSL converter.

In some embodiments, the trigger type identification further includes parsing the converted integration application to detect pre-determined trigger step keywords and attributing the trigger type in accordance with the detected trigger step keywords.

In some embodiments, the step of creating the integration application can be performed by an integration designer. In some embodiments, the integration designer may use a programming library.

In some embodiments, the trigger type can be identified by an integration manager.

In some embodiments, the trigger binding can be generated by an integration manager.

In some embodiments, the trigger type is one of: a file transfer protocol trigger type, a hypertext transfer protocol trigger type, a database trigger type, a message queue server trigger type, an object storage service trigger type, an email listener trigger type, and an event listener trigger type.

In some embodiments, the endpoint is one of a domain, an IP address, a uniform resource locator, a port number, and a hostname.

In accordance with another aspect of the present disclosure, there is also provided a method of executing an integration application. The method includes activating a trigger associated with the integration application, accessing a registry to obtain an integration application stored in the registry in accordance with the activated trigger, transmitting the obtained integration application to a dispatcher, and executing on an integration runner the transmitted integration application. In accordance with embodiments of the present disclosure, the dispatcher is operatively coupled to the integration runner.

In some embodiments, the trigger activation is performed in response to a data source providing one or more user requests.

In some embodiments, the integration runner is selected from a plurality of integration runners by the dispatcher based on a pre-defined algorithm.

In some embodiments, the transmission to a dispatcher further includes transmitting the user request payload.

In some embodiments, the integration runner is configured to execute multiple integration applications concurrently.

In some embodiments, the integration runner is configured to communicate with one or more source connectors and/or one or more data processor.

In some embodiments, the dispatcher is configured to adjust the number of the plurality of integration runners or the number of integration application(s) to run across the plurality of integration runners, based on one or more pre-defined algorithms.

In accordance with another aspect of the present disclosure, there is also provided a tangible, non-transitory computer readable medium having instructions recorded thereon to be performed by at least one processor to carry out a method as defined in any one of aforementioned methods.

In accordance with another aspect of the present disclosure, there is also provided a system configured to carry out a method as defined in any one of aforementioned methods. The system includes at least one processor and a tangible, non-transitory computer readable medium. The computer readable medium includes instructions recorded thereon to be performed by at least one processor of the system to carry out a method as defined in any one of aforementioned methods.

Embodiments of the present disclosure may provide technical advantages or benefits. In summary, the system and method of the present disclosure can enable scale-to-zero of executing the integration applications in the serverless cloud environment, and also enable cost-effective and reusable integration runners to further optimize the runtime resources in the system.

### BRIEF DESCRIPTION OF THE DRAWINGS

Further features and advantages of the present disclosure will become apparent from the following detailed description, taken in combination with the appended drawings, in which;

FIG. 1 shows an embodiment of a system architecture in accordance with the present disclosure.

FIG. 2 shows an embodiment of an integration application deployment method in accordance with the present disclosure.

FIG. 3 shows an embodiment of an integration application deployment method in accordance with the present disclosure.

FIG. 4 shows an embodiment of an integration application execution method in accordance with the present disclosure.

FIG. 5 shows an embodiment of how the dispatcher implements the scale-up functions/operations on the application runners in accordance with the present disclosure.

FIG. 6 shows an embodiment of how the dispatcher implements the scale-down functions/operations on the application runners in accordance with the present disclosure.

FIG. 7 shows an embodiment of how the dispatcher implements the rebalance functions/operations on the application runners in accordance with the present disclosure.

FIG. 8 shows an embodiment of the integration runner design in accordance with the present disclosure.

FIG. 9 shows an electronic device in accordance with the present disclosure.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this disclosure belongs.

“Enterprise Integration Platform as a Service (EiPaaS)” refers to a combination of integration technology functionalities that are delivered as a suite of data and application integration capabilities with shared metadata that enable collaboration across different functions. An EiPaaS allows the enterprise business to integrate a broad variety of cloud and on-premises applications to facilitate hybrid data flows, synchronize data, improve operational workflows, and gain better visibility.

“Domain-Specific Language (DSL)” refers to a computer language that targets to a particular kind of problem, rather than a general-purpose language that aims at any kind of software problem. In relation to the present disclosure, the terms “DSL” and “DSL flow” are used interchangeably.

“File Transfer Protocol (FTP)” refers to a standard communication protocol used for the transfer of computer files from a server to a client on a computer network. FTP is built on a client-server model architecture using separate control and data connections between the client and the server. In other words, it is commonly used to download, upload, and transfer files from one location to another on the Internet and between computer systems.

“Application Programming Interface Gateway (APIG or API Gateway)” refers to an application programming interface management tool that sits between a client and a collection of backend services. In other words, an APIG acts as a “front door” or “proxy” for applications to access data, business logic or functionality from the backend services.

“Message Queue Server (MQS)” refers to a message queue manager which provides queuing services to one or more clients. For example, messages can be placed in a queue and held until delivery is guaranteed.

“Object Storage Service (OBS)” refers to a cloud based data storage service that is used to store unstructured data of any format and access the data through public APIs.

“Hypertext Transfer Protocol (HTTP)” refers to an application layer protocol in the internet protocol suite model, which is designed to transfer information between networked devices and runs on top of other layers of the network protocol stack. As the foundation of the World Wide Web, HTTP (or http) is used to load web pages using hypertext links.

“JavaScript Object Notation (JSON)” refers to a standard text-based format for representing structured data based on JavaScript object syntax. It is commonly used for transmitting data in web applications (e.g., sending some data from the server to the client, so it can be displayed on a web page, or vice versa).

“Serverless Cloud Environment” refers to a set of distributed computing systems managed by third party software vendors, which provides pay-per-use backend services. Users develop and deploy applications to such an environment without being concerned about the underlying backend services and infrastructure. Examples of serverless cloud environment can include Docker environment and Kubernetes environment.

“Docker Image” refers to a file used to execute codes to build a self-contained process running in a serverless cloud environment.

Furthermore, “scale-to-zero” parameter in a serverless cloud environment means that no process being run when there are no user requests, and only when there is a user request coming to the environment, a process is created and run (therefore, scale-to-zero is an effective way of saving the computing resources); and “integration runner” refers to a software/hardware combination that runs one or more integration applications.

A skilled person in the art should understand that “software integration” refers to a process of enabling independently designed applications, databases, and messaging systems to work together to provide new capacities or solve new problems; and “integration application” refers to a process flow developed to define/model the software integration which typically starts with a trigger and is followed by a series of steps to completion.

For example, the trigger can be a new file being dropped to a File Transfer Protocol (FTP) server folder, and subsequently the new file is converted into JavaScript Object Notation (JSON) data object which is further split into several small JSON data items, and finally each JSON data item is inserted into the database.

With the prior art solutions, the integration applications must be always running in order to receive incoming user requests. If no application is running when a user request arrives, the integration application will not be triggered. In other words, once started or activated, the application cannot be stopped even when there are no incoming user requests. In another example, to cater for different kinds of integration applications, the prior art solutions must maintain different docker images for the integration runners and deploy different integration runners in the environment. In the prior art solutions, these integration runners cannot be reused to run different kinds of integration applications. Therefore, the cost of maintaining these non-reusable integration runners (e.g., Kubernetes pods used in the prior art solutions) increases rapidly as the number of integration applications increases.

Accordingly, the present disclosure provides a method and system to obviate or mitigate one or more limitations of the prior art solutions. Thus, the present disclosure relates to a system and method of running integration applications cost-effectively in a serverless cloud environment.

In accordance with embodiments of the present disclosure, a system and method of running integration applications in the serverless cloud environment includes two parts: integration application deployment and integration application execution.

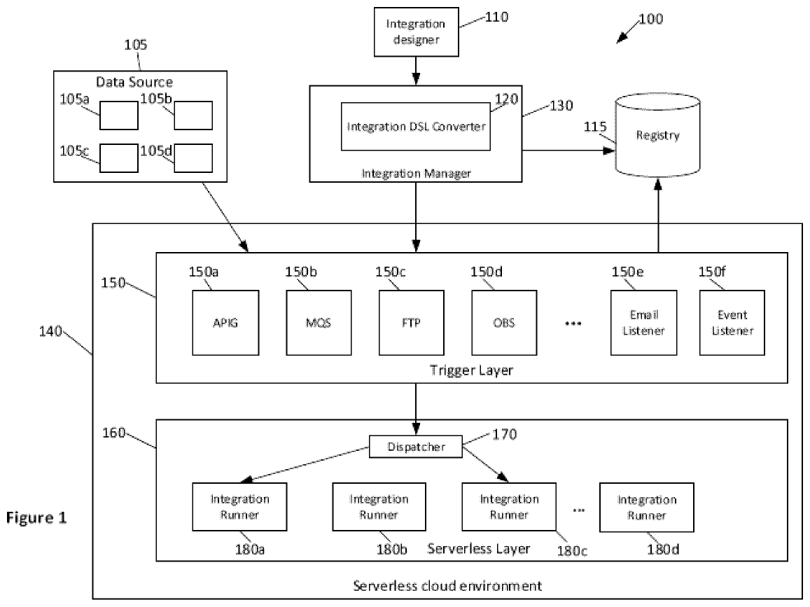

FIG. 1 shows a system 100 according to an embodiment of the present disclosure. The system 100 may include a data source 105, an integration designer 110, an integration DSL converter 120, an integration manager 130 and a serverless cloud environment 140 which includes a trigger layer 150 and a serverless layer 160. In some embodiments, the system 100 may further include a registry database 115. In other words, the registry database 115 can be either an internal entity of the system 100 or an external entity to the system 100.

Referring to FIG. 1, the data source 105 is coupled to the trigger layer 150, which includes triggers 150a, 150b, 150c, . . . , etc. The triggers comprised in the trigger layer 150 may include an APIG trigger 150a, a MQS trigger 150b, an FTP trigger 150c, an OBS trigger 150d, an email listener trigger 150e, an event listener trigger 150f, . . . etc. The data source 105 may be a hypertext transfer protocol (http) data source 105a, a database 105b, an FTP file server 105c, a message system 105d, . . . etc. Some triggers (such as the APIG trigger 150a) may respond to incoming user requests from the data source 105 (e.g., http data source 105a), while some other triggers (such as the FTP trigger 150c) may poll the user requests (e.g., the FTP file server 105c) for input of a text file to be uploaded to an FTP server. The serverless layer 160 may include a dispatcher 170 and one or more integration runners 180a, 180b, 180c, 180d, . . . etc. In some embodiments, the dispatcher 170 is operatively coupled or connected to the integration runners 180a, 180b, 180c, etc.

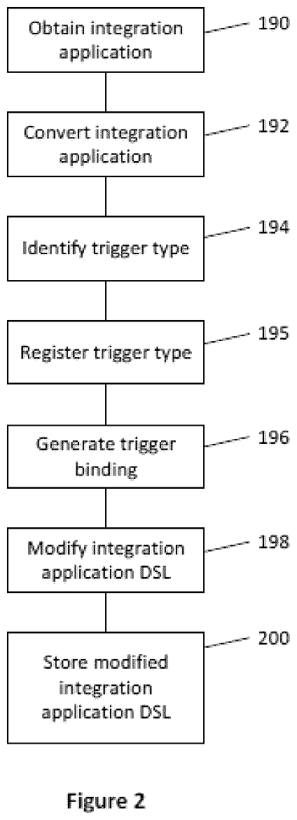

FIG. 2 shows a flowchart of an embodiment of a method for deploying an integration application, in accordance with the present disclosure. At action 190, an integration application is obtained. In some embodiments, the integration application may be obtained from an integration designer, which generates the integration application (e.g., the integration designer 110 at FIG. 1). At action 192, the integration application may be converted to a DSL in accordance with the integration runner that will run the integration application. In some embodiments, the integration application conversion to DSL may be performed by an integration DSL converter (e.g., the integration DSL converter 120 at FIG. 1). At action 194, the trigger type that is part of the integration application DSL is identified.

In the context of the present disclosure, a trigger type is a protocol to be invoked to connect to an endpoint such as, for example, a domain, an IP address, a uniform resource locator, a port number, and a hostname. A trigger type has associated thereto a predetermined sequence of characters (a string) or a keyword that may be used when generating an integration application DSL.

Examples of trigger types include an FTP trigger, a HTTP trigger, a database trigger, etc. The identification of a trigger type in an integration application DLS may be performed by parsing the integration application DSL to identify predetermined trigger step keywords or predetermined sequences of characters. Table 1 shows an example of a list of trigger step keywords and the trigger type attributed when the trigger step keywords are detected in the integration application DSL. In some embodiments, the identification of the trigger type may be performed by an integration manager (e.g., the integration manager 130 at FIG. 1). Different or additional trigger step keywords and trigger types are to be considered within the scope of the present disclosure.

TABLE 1

| Trigger Step Keywords | |
|---|---|
| (Sequences of Characters) | Trigger Type |
| <from uri=“ftp:// | FTP |
| <from uri=“http:// | HTTP |
| <from uri=“sql: | Database |
| <from uri=“kafka:// | MQS |
| <from uri=“jetty:// | APIG |
| <from uri=“obs:// | OBS |
| <from uri=“email:// | Email listener |
| <from uri=“eventgrid:// | Event listener |

Referring to FIG. 2, at action 195 the trigger identified at action 194 may be stored in a trigger layer (e.g., the trigger layer 150 at FIG. 1). At action 196 a trigger binding may be generated and, at action 198, the trigger binding may be substituted to the trigger step in the integration application DSL to obtain a modified integration application DSL. That is, the original integration application DSL is modified to specify a trigger binding rather than the original trigger step.

As an example, an original application integration DSL may include the following:

```
<routes>
  <route>
    <from uri=“ftp://192.168.0.20/price_folder/”>
    <marshal language=“json”/>
    <split>
      <jsonpath>$.price_list </jsonpath>
      <to uri=“sql:insert into price_list (id, product, price, quantity)
        values ($.body.id, $.body.product, $.body.price,
        $.body.quantity)”/>
    </split>
  </route>
</routes>
```

which has an FTP trigger type that may be identified. Any suitable trigger binding may be generated. As an example, the trigger binding may be as follows:

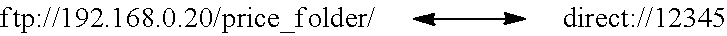

In the present embodiment, “direct://12345” is a system generated internal trigger which is used by the integration runner to execute the integration application.

A modified integration application DSL is obtained by substituting the trigger binding to the FTP trigger. The modified integration application DSL may be expressed as:

```
<routes>
  <route>
    <from uri=“direct//12345”>
    <marshal language=“json”/>
    <split>
      <jsonpath>$.price_list </jsonpath>
      <to uri=“sql:insert into price_list (id, product, price, quantity)
        values ($.body.id, $.body.product, $.body.price,
        $.body.quantity)”/>
    </split>
  </route>
</routes>
```

At action 200 the modified integration application DSL may be stored into a registry (e.g., the registry 115 at FIG. 1).

In some embodiments, there is one trigger binding for each potential valid payload that may be identified by the data source 105 to the trigger layer 150.

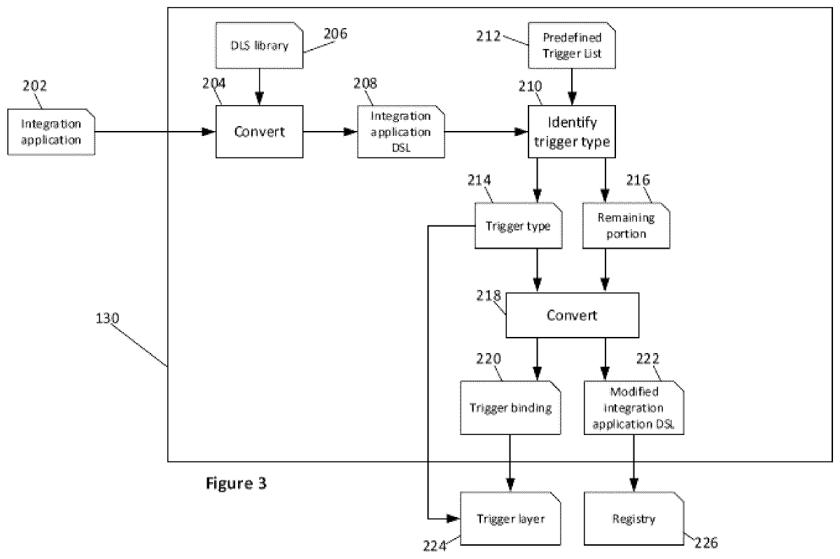

FIG. 3 shows another flowchart of an embodiment of a method for deploying an integration application, in accordance with the present disclosure. FIG. 3 shows an integration application 202 being obtained by an integration manager 130. The integration application 202 is converted into an integration application DSL at action 204, which may require input from a DSL library 206. The conversion action 204 results in an integration application DSL 208. The integration application DSL 208 is input to a trigger type identification action 210, where a trigger type of a trigger present in the integration application DSL 208 is identified. The trigger type identification action 210 may require input form a pre-defined trigger list 212. The trigger type identification action 210 produces a trigger type file 214 and a remaining portion file 216 of the integration application DSL 208. As will be understood by a skilled worker, in some embodiments, a distinct integration application is generated and subjected to DSL conversion and trigger type identification for each possible payload or domain or IP address. As an example, subjecting the aforementioned application integration DSL:

```
<routes>
  <route>
    <from uri=“ftp://192.168.0.20/price_folder/”>
    <marshal language=“json”/>
    <split>
      <jsonpath>$.price_list </jsonpath>
      <to uri=“sql:insert into price_list (id, product, price, quantity)
        values ($.body.id, $.body.product, $.body.price,
        $.body.quantity)”/>
    </split>
  </route>
</routes>
```

to the trigger type identification action 210 would result in a trigger type file containing trigger_type=ftp and the remaining portion file:

```
<routes>
  <route>
    <marshal language=“json”/>
    <split>
      <jsonpath>$.price_list </jsonpath>
      <to uri=“sql:insert into price_list (id, product, price, quantity)
        values ($.body.id, $.body.product, $.body.price,
        $.body.quantity)”/>
    </split>
  </route>
</routes>
```

At action 218, the trigger type file 214 and the remaining portion file 216 are subjected to a conversion (transformation) operation that generates a trigger binding 220 and a modified integration application DSL 222.

In accordance with the embodiments, the integration DSL converter (120 of FIG. 1) can internally generate a system trigger of such format: direct://<number>, where <number> is a unique and random integer (for example: direct://12345). A complete example is shown as follows:

```
<routes>
  <route>
    <from uri=“direct://12345”>
      <marshal language=“json”/>
      <split>
      <jsonpath>$.price_list </jsonpath>
      <to uri=“sql:insert into price_list (id, product, price, quantity)
        values ($.body.id, $.body.product, $.body.price,
        $.body.quantity)”/>
      </split>
  </route>
</routes>
```

Accordingly, the trigger binding is achieved by mapping the original trigger to the internal system generated trigger, as shown in the example below:

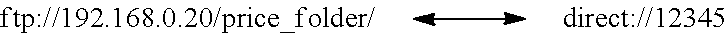

The trigger type 214 and the trigger binding 220 are stored in the trigger layer 224. The modified integration application DSL 222 is stored in the registry 226. An example of a modified integration application is provided elsewhere in the present disclosure.

Another example of trigger binding is provided below in relation to an original integration application DSL of the form:

```
<routes>
  <route>
    <from uri=“http://www.mysite.com/users/”, method=”post”/>
      <logger type=“info” message=”$.body” />
      <to uri=“sql:insert into user_list (id, firstName, lastName, age)
        values ($.body.id, $.body.first_name, $.body.last_name,
        $.body.age)”/>
  </route>
</routes>
```

A search for keywords locates “<from uri=“http://” and identifies the trigger type as a HTTP trigger type and the remaining portion of the of the integration application DSL as being:

```
<routes>
  <route>
    <logger type=“info” message=”$.body” />
    <to uri=“sql:insert into user_list (id, firstName, lastName, age)
      values ($.body.id, $.body.first_name, $.body.last_name,
      $.body.age)”/>
  </route>
</routes>
```

Subsequently, an internal trigger with a unique number is generated (e.g., in a format: direct://<number>) and the remaining portion of the integration application DSL is transformed to:

```
<routes>
  <route>
    <from uri=“direct://8373920”/>
      <logger type=“info” message=”$.body” />
      <to uri=“sql:insert into user_list (id, firstName, lastName, age)
      values ($.body.id, $.body.first_name, $.body.last_name,
      $.body.age)”/>
  </route>
</routes>
```

The HTTP trigger is bound to the generated internal trigger as follows:

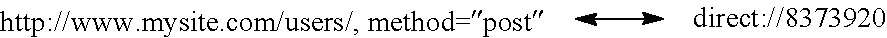

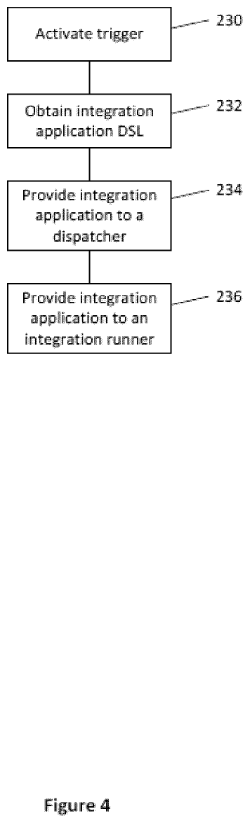

FIG. 4 show a flowchart of an embodiment of a method of executing an integration application. At action 230, a trigger associated with an integration application is activated. The activation of the trigger at action 230 may be carried out in several different ways. As an example, a trigger may be activated in response to a data source (e.g., the data source 105 at FIG. 1) providing a user request (or multiple user requests) to a trigger layer in which the trigger is stored (e.g., the trigger layer 150 at FIG. 1 or the trigger layer 224 at FIG. 3). Activating the trigger may include capturing a user request payload. For example, if the trigger type is an FTP trigger type, then when a user uploads a file to FTP server folder, the FTP trigger is activated, and the file content is captured as request payload. Subsequently, at action 232, an integration application DSL is obtained in accordance with activated trigger. As an example, the integration application DSL may be the modified integration application DSL 222 shown at FIG. 3. As another example, the activation of a trigger may be detecting that a text file has been uploaded to a FTP file server. In this case, the user request is the text file being uploaded and the payload is the content of the text file.

At action 234, the obtained integration application DSL and, if appropriate, the requested payload is provided to a dispatcher (e.g., the dispatcher 170 at FIG. 1). In turn the dispatcher may provide, at action 236, the obtained integration application DSL to an integration runner (e.g., the integration runner 180a at FIG. 1) located in a serverless layer for execution. See, for example, the serverless layer 160 at FIG. 1.

In some embodiments, the dispatcher may be configured to monitor and control the integration runners present in the serverless layer (cloud). For example, the dispatcher may be configured to dynamically modify (increase or decrease) the number of the integration runners as needed and rebalance the number of integration applications running within individual integration runners.

In accordance with the present disclosure, FIGS. 5, 6 and 7 respectively show block diagrams of embodiments of how a dispatcher may implement scale-up, scale-down and rebalance functions/operations on the application runners. In the embodiments of FIGS. 5, 6 and 7, the dispatcher 170 monitors and controls the workload of the underlining integration runners and ensure that the integration runners are not running overflow or causing system performance degradation.

Therefore, the dispatcher 170 may be configured to dynamically increase or reduce the number of existing runners, and to move the integration applications from one runner to another runner in order to rebalance the workload across the runners, when needed. The dispatcher 170 may define and use three metrics or parameters to monitor and control the workload of the integration runners, the three metrics being: capacity, high threshold, and low threshold.

In accordance with the embodiments, the capacity refers to the maximum number of applications (e.g., integration DSL flows) that can be executed in one single integration runner at any time. When the (maximum) capacity is reached at an integration runner, the dispatcher 170 cannot send any new integration DSL(s) to this particular integration runner. Accordingly, the dispatcher 170 must choose another available integration runner to execute the new integration DSL(s).

In accordance with the embodiments, the high threshold is a predefined number of applications (e.g., integration DSL flows) that can be executed in one single integration runner at a given or selected time. It can be equivalent to or less than the (maximum) capacity. For example, an integration runner can run maximum 10 integration DSLs at any time (i.e., capacity=10), but the user can choose to set the high threshold to 8 integration DSLs at selected times (e.g., Mondays and Tuesdays) and changes it to 10 integration DSLs at another selected times (e.g., Wednesdays and Thursdays).

In relation to the present disclosure, the high threshold is used for the dispatcher 170 to decide whether/when a new integration runner (or runners) should be created or added in the serverless cloud environment. In a scale-up scenario, when the number of integration DSL flows running on all the existing integration runners exceeds the predefined high threshold, the dispatcher 170 will create or add a new integration runner (or runners) to execute new integration DSLs. For example, as illustrated in FIG. 5, when the predefined high threshold is 8, the first runner 180a has 8 running or executing applications, the second runner 180b has 9 running or executing applications and the third runner 180c has 8 running or executing applications (i.e., the workload of each of the existing integration runners exceeds the predefined high threshold), accordingly the dispatcher 170 will create a new runner in the system.

In accordance with the embodiments, the low threshold is another predefined number of applications (e.g., integration DSLs) that can be executed in one single integration runner at a given or selected time. It can be equivalent to or less than the high threshold. For example, an integration runner can run maximum 10 integration DSLs at any time (i.e., capacity=10), and the user can choose to set the high threshold to 8 integration DSLs and the low threshold to 2 integration DSLs at selected times (e.g., Mondays and Tuesdays).

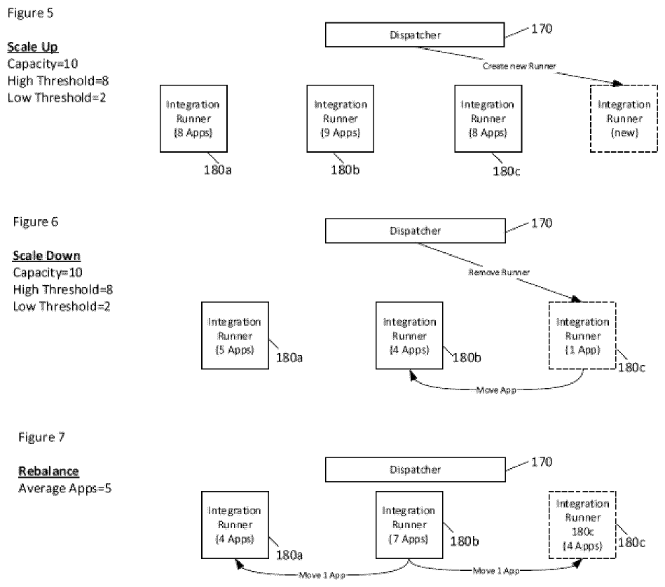

In relation to the present disclosure, the low threshold is used for the dispatcher 170 to decide whether/when the number of existing integration runners should be reduced (or one or more existing integration runners should be removed) in the serverless cloud environment. In a scale-down scenario, when one integration runner is running the number of integration DSLs below the low threshold, the dispatcher 170 will move its running integration DSLs to other integration runners and remove this integration runner from the environment. For example, as illustrated in FIG. 6, when the predefined low threshold is 2, the first integration runner 180a has 5 running or executing applications, the second runner 180b has 4 running or executing applications, and the third runner 180c has only 1 running or executing application (i.e., the workload of the third runner is below the predefined low threshold), accordingly the dispatcher 170 may remove the third runner 180c and move its workload (i.e., the only 1 application) to one of the existing integration runners (e.g., the second runner 180b).

In a rebalance scenario, when the dispatcher 170 detects some integration runners are running (significantly) more applications (e.g., integration DSLs) than other runners, the dispatcher 170 may calculate the average number of applications (e.g., integration DSLs) running in each integration runner, and move the applications from the integration runner(s) which are running a relatively higher workload to the integration runner(s) which are running a relatively lower workload. For example, as illustrated in FIG. 7, the first runner 180a has 4 applications, the second runner 180b has 7 running or executing applications, and the third runner 180c has 4 running or executing applications (i.e., the average number of applications for each runner is 5), accordingly the dispatcher may move 1 application from the second runner 180b to the first runner 180a and another 1 application from the second runner 180b to the third runner 180c. Eventually each of the three runners will have 5 running or executing applications.

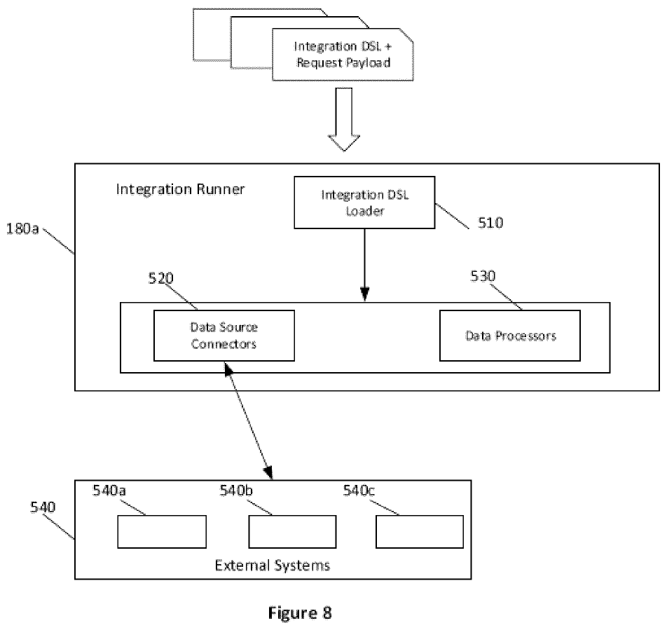

In accordance with the present disclosure, FIG. 8 shows a block diagram of an embodiment of an integration runner design. In some embodiments, the integration runners (180a, 180b, 180c, . . . , etc.) can execute different kinds of integration DSLs and can run multiple of these DSLs concurrently. In some embodiments, all the integration runners are created as a single docker image. The integration runner may include various modules internally, for example, a loader, a connector, a processor, or the like.

As illustrated in FIG. 8, the integration runner (for example the integration runner 180a) uses an integration DSL loader 510 to load an integration application DSL and request payload for execution. As an example, the integration application DSL may be the modified integration application DSL 222 shown at FIG. 3. When executing the integration application DSL, the integration runner allows communication with external systems 540 via one or more data source connectors 520 (e.g., to access the external systems to request or produce data). The external system may be a database system 540a, an FTP file system 540b, an email system 540c, . . . etc. Furthermore, the integration runner uses one or more data processors 530 to process or transform the received integration DSL and request payload (for example, data filtering, data sorting, data enrichment, and the like). For example, data coming from the request payload to the integration runner is processed via the data processors (within the integration runner) and it is further transmitted via a database connector (within the integration runner) to the external database system or via an email connector (within the integration runner) to the external email system.

Notably, for integration application deployment, any appropriate trigger registration algorithm can be used to achieve the same objective of separating the trigger step (or the trigger portion) from the remaining flow (or the integration execution portion) of the integration application DSL flow.

Similarly, for integration application execution, any appropriate algorithm can be used by the dispatcher to select the corresponding integration runner from the available integration runners (e.g., the action 236 in FIG. 4) and subsequently send the integration DSL and request payload to the selected integration runner for execution. For example, round-robin algorithm (i.e., where each process is assigned a fixed time slot or time slice in a cyclic or circular way, handling all processes without priority) can be used by the dispatcher to evenly distribute the workload. In another example, in a multi-tenant environment where workload isolation is required for each tenant, the dispatcher will choose the same integration runner to run all the integration applications of the same tenant.

Furthermore, in some embodiments, any appropriate rebalancing algorithm can be used to achieve the same objective of enabling cost-effective and reusable integration runners and optimizing the runtime resources in the serverless cloud environment. For example, the rebalancing algorithm can depend on calculating the average number of applications (e.g., integration DSLs) running in each integration runner, or any other appropriate methodology.

In accordance with another aspect of the present disclosure, there is also provided a tangible, non-transitory computer readable medium which may comprise instructions. When executed by a device, the instructions can cause the device to carry out the method or methods as described herein.

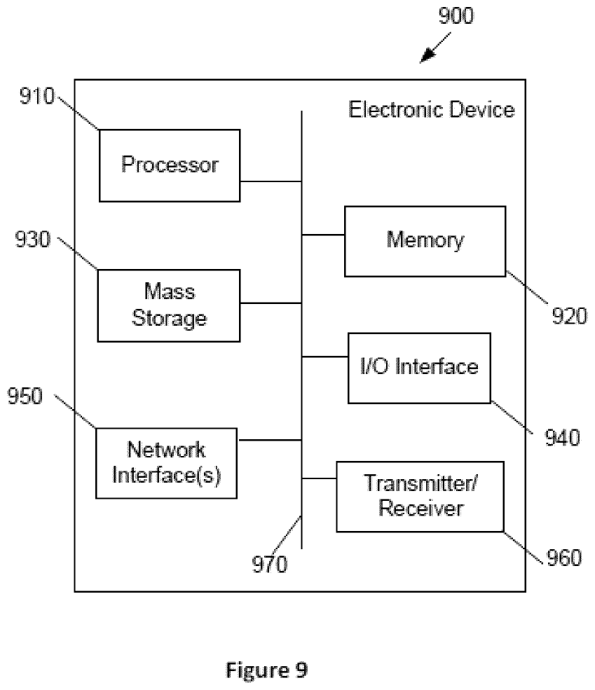

FIG. 9 is a schematic diagram of a device (e.g., an electronic device) 900 that may perform any or all of the steps of the above methods and features as described herein, according to different embodiments of the present disclosure. For example, end-user computers, smartphones, IoT devices, laptops, tablet personal computers, electronic book readers, gaming machine, media players, devices performing tasks in relation to generation of 2D or 3D images, physical machines or servers, or other computing devices can be configured as the electronic device. An apparatus configured to perform embodiments of the present disclosure can include one or more electronic devices for example as described in FIG. 9, or portions thereof.

As shown in FIG. 9, the device includes a processor 910, such as a Central Processing Unit (CPU) or specialized processors such as a Graphics Processing Unit (GPU) or other such processor unit, memory 920, non-transitory mass storage 930, I/O interface 940, network interface 950, and a transceiver 960, all of which are communicatively coupled via bi-directional bus 970. According to certain embodiments, any or all of the depicted elements may be utilized, or only a subset of the elements. Further, the device 900 may contain multiple instances of certain elements, such as multiple processors, memories, or transceivers. Also, elements of the hardware device may be directly coupled to other elements without the bi-directional bus.

The memory 920 may include any type of non-transitory memory such as static random-access memory (SRAM), dynamic random-access memory (DRAM), synchronous DRAM (SDRAM), read-only memory (ROM), any combination of such, or the like. The mass storage element 930 may include any type of non-transitory storage device, such as a solid-state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method steps described above.

An electronic device configured in accordance with the present disclosure may comprise hardware, software, firmware, or a combination thereof. Examples of hardware are computer processors, signal processors, application-specific integrated circuits (ASICs), field programmable gate arrays (FPGAs), silicon photonic chips, etc. The hardware can be electronic hardware, photonic hardware, or a combination thereof. The electronic device can be considered a computer in the sense that it performs operations that correspond to computations, e.g., receiving and processing signals indicative of image data, implementing a machine learning model such as a neural network model, updating parameters (weights) of the machine learning model, providing outputs of the machine learning model, etc. A machine learning model manager (e.g., a neural network manager) may be responsible for operating the machine learning model, for example by adjusting parameters thereof. The electronic device can thus be provided using a variety of technologies as would be readily understood by a worker skilled in the art.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device. The computer-readable medium may be non-transitory in the sense that the information is not contained in transitory, propagating signals.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

To summarize the above aspects, embodiments of the present disclosure may provide various technical advantages or benefits.

First, the system and method of the present disclosure is able to separate the trigger step (i.e., the first step) from the remaining flow of the integration application, so that the trigger (or triggers) can independently listen to or receive the incoming user requests and invoke the corresponding integration flow. Second, the system and method of the present disclosure is able to further identify the trigger type and register or store the trigger type and the trigger binding relationship/linkage to the trigger layer. Third, the system and method of the present disclosure is able to add the trigger binding relationship/linkage to the remaining flow of the integration application and store it in the registry database. Accordingly, these innovative features (e.g., the design of decoupling the trigger portion and the integration execution portion) would enable the integration application to be executed in an auto-scale serverless cloud environment. In other words, the system and method of the present disclosure would have the ability to “scale-to-zero” (i.e., there is no integration flow running) when there are no incoming user requests from the external data source to the trigger (or triggers), which will significantly save the resource cost of running the application integrations.

Fourth, the system and method of the present disclosure is able to activate the corresponding trigger and execute the converted integration DSL and the request payload in the integration runner. Fifth, the system and method of the present disclosure is able to dynamically increase or decrease the number of integration runners in the environment and rebalance the application workload across all the integration runners in the environment. Sixth, the system and method of the present disclosure enables one integration runner (e.g., in the form of one unified integration runner) to execute multiple or different types of integration applications (and also execute them concurrently), so that only one docker image is required to be created and maintained in the system. Furthermore, as each integration runner can execute multiple integration applications, the number of integration runners can be reduced in the environment. In other words, both the docker image and the integration runner process can be reused for different kinds of integration applications. Accordingly, these innovative features/designs would enable cost-effective and reusable integration runners to further optimize the runtime resources.

Therefore, the embodiments of the present disclosure can be used to provide a cost-effective way of running integration applications in a serverless cloud environment. In practice, the serverless cloud environment can be a public cloud, a private cloud, or a hybrid cloud. For example, a user (e.g., a cloud provider) or a product (e.g., in the area of EiPaaS cloud service, enterprise integration solution and product) using a private serverless cloud environment can apply the embodiments of the present disclosure to the company's own data center and build an internal EiPaaS system for the company's internal departments or the company's business partners.

The foregoing aspects of the disclosure are examples and can be varied in many ways. Such present or future variations are not to be regarded as a departure from the spirit and scope of the disclosure, and all such modifications as would be obvious to one skilled in art are intended to be included within the scope of the following claims.

1. A method of deploying an integration application, comprising:
converting the integration application into a domain specific language (DSL) to obtain a converted integration application;
identifying a trigger type in the converted integration application, the trigger type identifying a protocol to be invoked to connect to an endpoint;
storing the trigger type;
generating a trigger binding in accordance with the trigger in the converted integration application;
modifying the converted integration application by substituting to the trigger the trigger binding, to obtain a modified integration application; and
storing the modified integration application in a registry.

2. The method of claim 1, wherein the integration application conversion to the DSL is performed by an integration DSL converter.

3. The method of claim 1, wherein the trigger type identification further comprising:
parsing the converted integration application to detect pre-determined trigger step keywords; and
attributing the trigger type in accordance with the detected trigger step keywords.

4. The method of claim 1, wherein the trigger type identification is performed by an integration manager.

5. The method of claim 1, wherein creating the integration application is performed by an integration designer using a programming library.

6. The method of claim 1, wherein the trigger type is identified by an integration manager.

7. The method of claim 1, the trigger binding is generated by an integration manager.

8. The method of claim 1, wherein the trigger type is one of:
a file transfer protocol trigger type;
a hypertext transfer protocol trigger type;
a database trigger type;
a message queue server trigger type;
an object storage service trigger type;
an email listener trigger type; and
an event listener trigger type.

9. The method of claim 1, wherein the endpoint is one of: a domain, an IP address, a uniform resource locator, a port number, and a hostname.

10. A method of executing an integration application, comprising:
activating, in accordance with a request, a trigger associated with the integration application;
accessing a registry to obtain an integration application stored in the registry in accordance with the activated trigger;
transmitting the obtained integration application to a dispatcher; and
executing on an integration runner the transmitted integration application, wherein the dispatcher is operatively coupled to the integration runner.

11. The method of claim 10, wherein the request is a user request, the method further comprising receiving the user request from a data source.

12. The method of claim 11, wherein:
the user request includes a payload, and
activating the trigger comprises capturing the payload.

13. The method of claim 10, further comprising selecting, by the dispatcher and based on a predefined algorithm, the integration runner from a plurality of integration runners.

14. The method of claim 12, wherein transmitting the obtained integration application to the dispatcher further includes transmitting the payload to the dispatcher.

15. The method of claim 10, wherein the integration runner is an initial integration runner, and the transmitted integration application is an initial transmitted integration application, the method further comprising executing, on additional integration runners, additional transmitted integration applications.

16. The method of claim 15, wherein executing the additional transmitted integration application on the additional integration runners includes executing the additional integration runner concurrently with executing on the initial integration runner the transmitted integration application.

17. The method of claim 10, further comprising the integration runner communicating with one or more source connectors to request data.

18. The method of claim 10, further comprising the integration runner communicating with one or more data processor to obtain processed data.

19. The method of claim 13, further comprising the dispatcher adjusting a total number of the plurality of integration runners in accordance with an average number of integration applications running per integration runner.

20. A system comprising:
at least one processor; and
a tangible, non-transitory computer readable medium having instructions recorded thereon to be performed by the at least one processor to carry out a method as defined in claim 1.
